(19) United States
(12) Patent Application Publication
(10) Pub. No.: US 2002/0174707 A1
(43) Pub. Date: Nov. 28, 2002

(54) Work center position determining method and apparatus

(76) Inventors: Susumu Sawafuji, Mitaka-shi (JP); Shozo Katamachi, Mitaka-shi (JP); Kazuo Nakajima, Mitaka-shi (JP)

Correspondence Address: NIXON PEABODY, LLP, 8180 GREENSBORO DRIVE, SUITE 800, MCLEAN, VA, 22102, US

(21) Appl. No.: 10/154,905

(22) Filed: May 28, 2002

(30) Foreign Application Priority Data
May 28, 2001 (JP) 2001-158814

(51) Int. Cl. G01B 21/00

(52) U.S. Cl. 73/1.81; 33/1 R

(57) ABSTRACT

A cylindrically formed master work is inserted into a work socket hole, and the master work is held at the center of the work socket hole by injecting compressed air from the inner circumferential face of the work socket hole toward the center of the work socket hole. In this state, the master work is rotated, and the end face of the master work is imaged three times with a CCD camera at different rotational angles. By computing the positions of bore centers from the three sets of obtained image data and the center of a circle passing those bore centers, the external shape center of the master work projected on the CCD is determined. Thus, the position of the external shape center of the work is easily and accurately determined.

### BACKGROUND OF THE INVENTION

1. Field of the Invention

The present invention relates to a work center position determining method and apparatus, and more particularly to a work center position determining method and apparatus for determining the center position of a minute work.

2. Description of the Related Art

One of the available methods for measuring the eccentricity (the discrepancy between the centers of the external shape and the internal shape) of a minute cylindrical work, such as a ferrule, used as an optical fiber connector part is to image an end face of the work with a CCD camera and process the obtained image data. By this method, measurement is done in the following manner for instance.

First, a work is inserted into a work socket hole formed in a work holder. Then, air is injected from the inner circumference of the work socket hole toward its center, and the work is held at the center of the work socket hole. Next, an end face of the work is imaged with a CCD camera. The position of the center of the bore is figured out from the obtained image data.

Since the center of the external shape of the work inserted into the work socket here is held in a fixed position all the time by the centripetal action of the air, this position can be located in advance, and the eccentricity of the work can be figured out by calculating the discrepancy between this pre-located position of the center of the external shape and the position of the center of the bore determined by image processing.

The position of the center of the external shape of the work projected on the CCD is determined by using a master work of which the position of the internal shape center and that of the external shape center relative to the internal shape center is known, and the position of the external shape center relative to the internal shape center in this case is identified as the quantity and direction of its eccentricity. The direction of its eccentricity is determined by affixing a mark identifying the direction of eccentricity on an end face of the master work.

However, where the object of measurement is an infinitesimal work, such as a ferrule, it is extremely difficult to mark the direction of eccentricity on its end face (e.g., the outside diameter of a ferrule is 1.25 mm), resulting in the problem of impossibility to accurately determine the position of the external shape center.

### SUMMARY OF THE INVENTION

The present invention, attempted in view of this problem, is intended to provide an external shape center position determining method and apparatus for works capable of easily and accurately determining the position of the external shape center of a work.

In order to achieve the objects stated above, the present invention is directed to a work center position determining method for a work having a visually recognizable portion on an end face thereof, the method comprising the steps of: rotating the work in a circumferential direction thereof; imaging the end face of the work with an image pickup device; and determining, from an image obtained in the imaging step, a position of an external shape center of the end face of the work projected on the image pickup device.

According to the invention, the end face of the work, which has on its end face the visually recognizable portion is imaged with the image pickup device while the work is rotated in its circumferential direction. The position of the external shape center of the work end face projected on the image pickup device is determined from the image thereby obtained. According to this method, the portion provided on the work end face need not be accurately formed only if it allows recognition of the image, and the position of the external shape center of the work can be determined easily and yet accurately.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 shows a profile of a dimensional measuring apparatus;

FIG. 2 shows a plan of the dimensional measuring apparatus;

FIG. 3 illustrates a master work;

FIG. 4 illustrates an external shape center position determining method for works;

FIG. 5 illustrates a dimensional measuring method for works;

FIGS. 6(a) and 6(b) illustrate a work holder in another embodiment;

FIGS. 7(a), 7(b) and 7(c) illustrate a work holder in yet another embodiment;

FIGS. 8(a), 8(b) and 8(c) illustrate a work holder in yet another embodiment;

FIG. 9 shows a longitudinal section of the configuration of an essential part of a rotation drive mechanism in yet another embodiment;

FIG. 10 shows a longitudinal section of the configuration of an essential part of a rotation drive mechanism in yet another embodiment;

FIG. 11 shows a longitudinal section of the configuration of an essential part of a rotation drive mechanism in yet another embodiment; and

FIG. 12 illustrates an external shape center position determining method for works in yet another embodiment.

### DETAILED DESCRIPTION OF THE PREFERRED EMBODIMENTS

An external shape center position determining method and apparatus for works according to the present invention will be described below with reference to the accompanying drawings with respect to preferred embodiment.

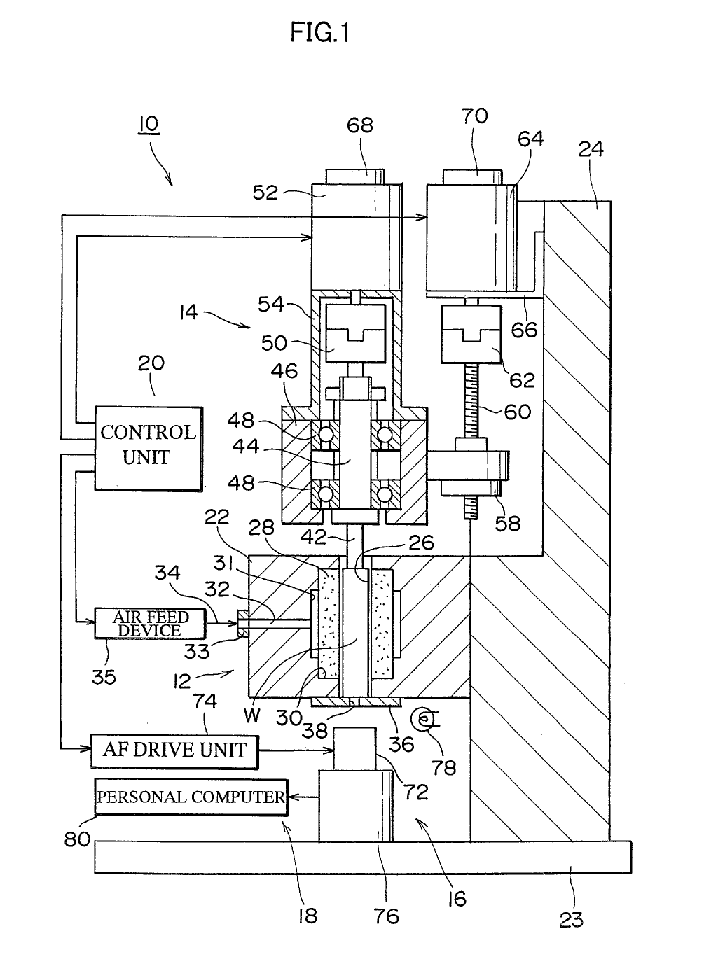

FIG. 1 shows a profile of a dimensional measuring apparatus into which an external shape center position determining apparatus for works according to the invention is incorporated. As illustrated in the drawing, a dimensional measuring apparatus 10 comprises a work holding unit 12 for holding a work W to be measured, a rotation drive unit 14 for rotating the work W held by the work holding unit 12 around its axis, an image pickup unit 16 for imaging the end face of the work W held by the work holding unit 12, an arithmetic and logic unit 18 for computing the dimensions of the work W on the basis of the image obtained by the image pickup unit 16, and a control unit 20 for controlling those other units.

The work holding unit 12 sets and holds the work W to be measured in a predetermined measuring position. As shown in FIG. 1, the work W is held by a work holder 22. The work holder 22 is formed in a columnar shape, and supported by a support 24 standing vertically on a base 23. In the central part of this work holder 22 is formed a work socket hole 26 along the axis, and the work W to be measured is inserted into and held by this work socket hole 26.

The inner wall face of the work socket hole 26 comprises a porous body (sintered metal) 28. The porous body 28 is formed in a cylindrical shape, and fitted into a hole 30 bored in the work holder 22. In the inner circumferential face of the hole 30 is formed a groove 31 in the circumferential direction, and the groove 31 communicates with an air intake port 33 via an air channel 32. To this air intake port 33 is connected an air feed device 35 via air feed piping 34, and compressed air is fed from this air feed device 35. Compressed air fed to the air intake port 33 passes the air channel 32 to be supplied into the groove 31, and uniformly injected toward inside of the work socket hole 26 from the inner circumferential face of the porous body 28 formed in a cylindrical shape.

At the end of the work socket hole 26, there is fitted a stopper plate 36. The stopper plate 36 is formed in a plate shape, and has a peep hole 38, smaller in diameter than the work socket hole 26, coaxially with the work socket hole 26. The work W inserted into the work socket hole 26 is prevented by this stopper plate 36 from falling, and its end face is imaged through the peep hole 38 formed in this stopper plate 36 by a CCD to be described in more detail afterwards.

The rotation drive unit 14 brings a rod 42 into contact with the rear end face of the work W held by the work holder 22, and by rotating this rod 42 turns the work W around the axis with the frictional force of the contact face.

As shown in FIG. 1, the rod 42 is arranged coaxially with the work socket hole 26 and formed smaller in diameter than the work W to be measured. This rod 42 is fitted coaxially with and at the end of a rotation shaft 44 arranged perpendicularly. The rotation shaft 44 is borne by bearings 48 and 48 provided on a liftable block 46, and its rear end is linked to the output shaft of a rotation drive motor 52 via a coupling 50. The rotation drive motor 52 is installed on the upper part of the liftable block 46 via a motor bracket 54. By driving this rotation drive motor 52, it causes the rod 42 to rotate around the axis.

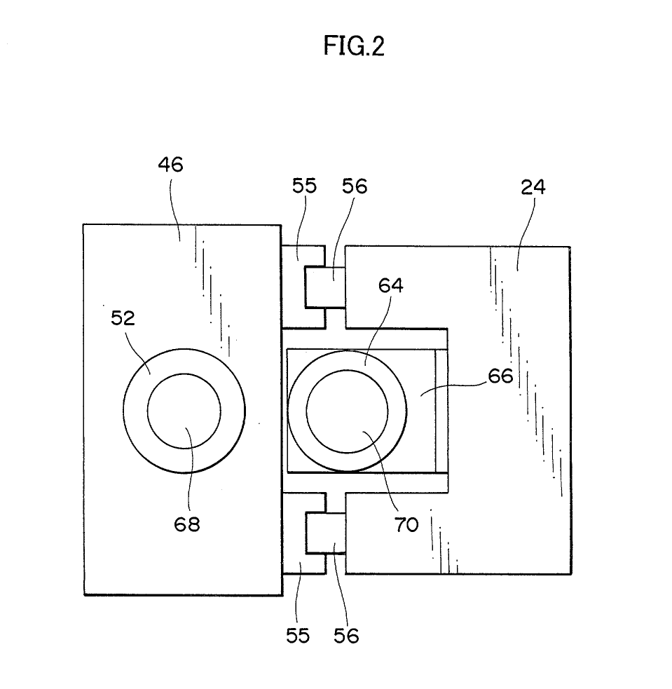

Behind the liftable block 46 are arranged a pair of sliders 55 and 55 as shown in FIG. 2. These sliders 55 and 55 are slidably supported on a pair of rails 56 and 56 laid in front of the support 24.

Behind the liftable block 46 is arranged a nut member 58 as shown in FIG. 1. This nut member 58 is hinged onto a threaded rod 60 arranged between the pair of rails 56 and 56. The threaded rod 60 is disposed perpendicularly, with its top end linked to the output shaft of a lift drive motor 64 via a coupling 62. The lift drive motor 64 is supported by the support 24 via a motor bracket 66, and by driving this lift drive motor 64, the threaded rod 60 is rotated. The rotation of this threaded rod 60 lifts or lowers the liftable block 46 according to the quantity of its rotation, resulting in an up or down movement of the rod 42 in a perpendicular direction along the axis.

The rotation drive motor 52 and the lift drive motor 64 are fitted with encoders 68 and 70, respectively, so that the revolutions of their respective output shafts can be determined.

The image pickup unit 16 images with the CCD camera the end face of the work W held by the work holder 22. This image pickup unit 16 comprises an AF lens unit 72, an AF drive unit 74, the CCD camera 76 and a lighting unit 78.

The AF lens unit 72 is fitted to the CCD camera 76, and projects the image of the end face of the work W held by the work holder 22 onto a CCD built into the CCD camera 76 in a magnified size. This AF lens unit 72 is arranged underneath the work holder 22 so as to be opposite the end face of the work W held by the work holder 22.

The AF drive unit 74 subjects the AF lens unit 72 to AF drive. This AF drive unit 74 is provided with a range finding sensor (not shown, and subjects the AF lens unit 72 to AF drive on the basis of information on the distance to the work end face provided by this range finding sensor. Thus, it focuses the AF lens unit 72 on the end face of the work W held by the work holder 22.

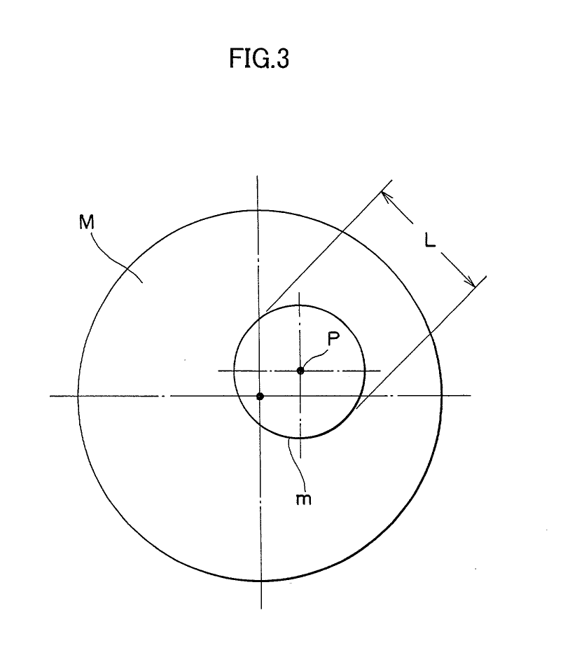

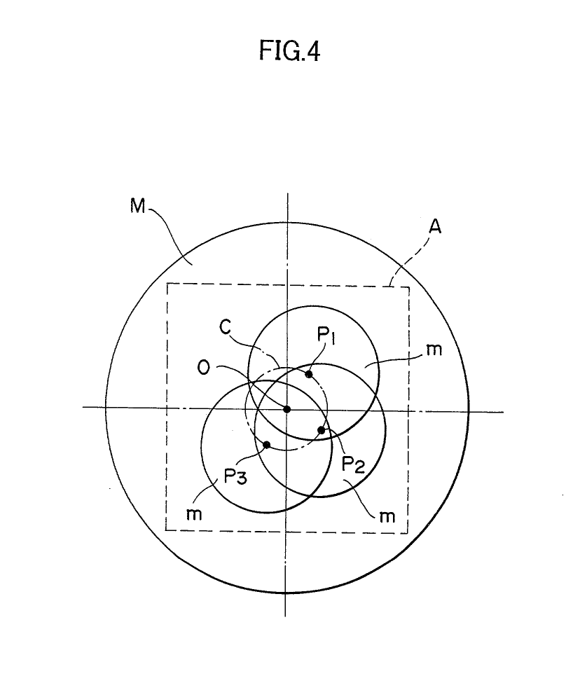

The CCD camera 76, installed on the base 23, images with its built-in CCD the end face of the work W magnified by the AF lens unit 72. To describe it in more detail, the CCD camera 76 images the end face of the work W through the peep hole 38, and in the obtained image a predetermined area A including the bore m of the work is magnified (see FIG. 4).

The lighting unit 78 irradiates the end face of the work W held by the work holder 22 with illuminating light.

The arithmetic and logic unit 18 determines the dimensions of the work W by image processing on the basis of the image of the end face of the work W obtained by the CCD camera 76. This arithmetic and logic unit 18 comprises a personal computer (PC) 80. The image data obtained by the CCD camera 76 are entered into the PC 80 via an image processing board (not shown), and various factors are determined by image processing in accordance with an image processing program stored in advance.

This PC 80 is provided with a display for displaying use (not shown) and a keyboard (not shown) as an input device. Various items of set information are entered from the keyboard, and the results of determination are displayed on the display unit.

The control unit 20 controls individual device constituting the dimensional measuring apparatus 10 on the basis of control signals from the PC 80.

The work center position determining method and the dimensional measuring method used by the dimensional measuring apparatus 10 configured as described are as follows.

First, initial setting is done. Thus, by using a master work M, the magnification X of the image projected on the CCD and the external shape center position O of the work projected on the CCD are figured out. As the master work M, as shown in FIG. 3, a cylindrical item, similar to the work W to be measured, which has a known bore size L is used.

First, the master work M is inserted into the work socket hole 26 formed in the work holder 22. The end of the master work M inserted into the work socket hole 26 is engaged with the stopper plate 36 and accommodated within the work socket hole 26.

Next, the air feed device 35 is driven, and compressed air of a predetermined pressure is fed into the air intake port 33. The compressed air fed to this air intake port 33 is uniformly injected toward inside the work socket hole 26 from the inner circumferential face of the porous body 28, and the master work M inserted into the work socket hole 26 is thereby held at the center of the work socket hole 26 in the horizontal direction while being engaged with the stopper plate 36 in the vertical direction. As a result, the master work M is positioned as predetermined for the measuring purpose.

As the master work M is positioned as predetermined, then the lighting unit 78 is driven, the end face of the master work M is irradiated with illuminating light.

Next, the AF drive unit 74 is driven to subject the AF lens unit 72 to AF drive. Thus, the AF lens unit 72 is focused to be in focus on the end face of the master work M held by the work holder 22. After it is focused, the end face of the master work M is imaged by the CCD camera 76 (first pickup).

Then, the lift drive motor 64 is driven to bring down the rod 42, which has been placed in a predetermined standby position, to a predetermined rotation drive position (the state illustrated in FIG. 1).

Next, the work rotation drive motor 52 is driven to drive the rotation of the rod 42 at a predetermined speed. As the rear end face of the master work M is in contact with the end of the rod 42 in this state, the rotation of the rod 42 causes the master work M to turn around its axis by the friction between their contact faces.

Then, the work lift drive motor 64 is driven to raise the rod 42 to the predetermined standby position. As the rod 42 moves away from the master work M, the master work M stops turning. Hereupon, the end face of the master work M having stopped turning is imaged by the CCD camera 76 at a different rotational angle from the first pickup (second pickup).

Next, the work lift drive motor 64 is driven again to bring down the rod 42, which has been placed in the predetermined standby position, to the predetermined rotation drive position. Then, the work rotation drive motor 52 is driven to rotate the rod 42 at the predetermined speed, and the master work M is turned around its axis.

Then, the work lift drive motor 64 is driven to raise the rod 42 to the predetermined standby position. This causes the rod 42 to move away from the master work M, and the master work M stops turning. Hereupon, the end face of the master work M having stopped turning is imaging by the CCD camera 76 at a rotational angle different from both the first and second pickups (third pickup).

The three sets of image data obtained by the CCD camera 76 are supplied to the PC 80, which computes the external shape center position O of the master work M projected on the CCD in accordance with the image processing program stored in advance in the following manner.

As shown in FIG. 4, first, three internal shape center positions P₁, P₂ and P₃ are computed from the obtained image data. Then, the center position of a circle C passing the three internal shape center positions P₁, P₂ and P₃ is computed. The center of this circle C is the sought position O of the external shape center of the master work M.

Thus, the master work M held by the work holder 22 rotates with its external shape center kept in the same position all the time by the centripetal action of air. Therefore, as the bore m of the master work M rotates around the external shape center of the master work M, if at least three center positions of this bore m are found, the position of the external shape center can be determined by figuring out a point at equal distance from the three internal shape center positions that have been found.

In this way, the PC 80 computes the position O of the external shape center of the master work M by determining the three internal shape center positions P₁, P₂ and P₃ from the three sets of image data obtained at different rotational angles and locating the center position of the circle C passing the three internal shape center positions P₁, P₂ and P₃. Then, it sets the position so computed of the external shape center as the origin of the measuring system.

The PC 80, by using one of the three sets of image data, computes the magnification X on the basis of the known bore size L, and stores the computed magnification X into a memory. The known bore size L is entered into the PC 80 in advance by the operator using the keyboard (not shown).

This series of steps completes the initial setting. Upon completion of the initial setting, the drive by the air feed device 35 is stopped, and so is the compressed air feed into the work socket hole 26. After that, the master work M is retrieved from the work socket hole 26.

Upon completion of the initial setting as described above, the bore size d and the eccentricity ω (the discrepancy between the center of the external shape and that of the internal shape) of the work W to be measured are measured. This measurement is accomplished in the following manner.

First, the work W to be measured is inserted into the work socket hole 26. The work W inserted into the work socket hole 26, with its end being engaged with the stopper plate 36, is accommodated within the work socket hole 26.

When the work W is inserted into the work socket hole 26, the air feed device 35 is driven to feed compressed air of a predetermined pressure into the air intake port 33. This causes the work W inserted into the work socket hole 26 to be held at the center of the work socket hole 26 in the horizontal direction while being engaged with the stopper plate 36 in the vertical direction. As a result, the work W is positioned as predetermined for the measuring purpose.

When the work W is positioned as predetermined for the measuring purpose, the lighting unit 78 is driven to irradiate the end face of the work W with illuminating light.

Then, the AF lens unit 72 is focused on the end face of the work W held by the work holder 22, and the image of that end face of the work W is obtained by the CCD camera 76.

The image data obtained by the CCD camera 76 are supplied to the PC 80, which computes the bore size d and the eccentricity ω in the following manner in accordance with the image processing program stored in advance.

As illustrated in FIG. 5, first the PC 80 computes the bore size d from the obtained image data on the basis of the known magnification X.

Next, the PC 80 computes the center P (bore center) of the bore w of the work W from the obtained image data and then the distance between the computed bore center P and the preset original O. This distance is the eccentricity ω that is sought for.

Thus, the work W is held at center of the work socket hole 26 by the centripetal action of air, and the position of its external shape center coincides with the position O of the external shape center of the master work M when the master work M is held. Therefore, by figuring out the distance from the position of the external shape center of the master work M, namely the position of the set original O, to the position P of the bore center of the work W, the eccentricity ω can be determined.

The PC 80 stores the determined bore size d and the eccentricity ω into the memory, and displays them on the display (not shown).

This series of steps completes the measurement and, upon completion of the measurement, the drive by the air feed device 35 is stopped, and so is the compressed air feed into the work socket hole 26. Then the work lift drive motor 64 is driven to raise the rod 42 to the predetermined standby position. After that, the work W is retrieved from the work socket hole 26, and the next work W to be measured is fed into the work socket hole 26. Then, the bore size d and the eccentricity ω of that work W are measured in the same procedure.

As hitherto described, the dimensional measuring apparatus 10 in this embodiment can easily and accurately set the origin O of the measuring system. Also, regarding the master work M used in setting the origin O of the measuring system, the quantity of eccentricity and the direction of eccentricity need not be known in advance as according to the prior art, but then can be easily set forth. This feature is particularly useful where the work to be measure is an infinitesimal component, such as a ferrule.

Although the master work M used in this embodiment is cylindrically shaped like the work to be measured, it need not be cylindrical, but only requires a visually perceivable portion on its end face. For instance, a work marked with a circle on an end face of a column can be used as well.

In addition, though the bore center of the master work M used herein is off its external shape center, this eccentricity is not absolutely necessary. In this case, all the three internal shape center positions P₁, P₂ and P₃ from the three sets of image data obtained at different rotational angles are exactly the same, and this common position of the internal shape center positions proves to be the position of the external shape center.

While in this embodiment the peep hole 38 is formed in the stopper plate 36 arranged at the end of the work socket hole 26 and part of the air injected into the work socket hole 26 is discharged via this peep hole 38, the end of the work socket hole 26 may as well be sealed with a transparent stopper plate. In this case, compressed air fed to the inner circumferential face of the work socket hole 26 is injected from the upper part of the work socket hole 26, the master work M inserted into the work socket hole 26 is lifted by the effect of the upward stream of air, positioning can be accomplished by bringing the rear end of this lifted master work M into contact with the end face of the rod 42. Then, the end face of the master work M so positioned can be imaged by the CCD camera 76 from the transparent stopper plate 36.

The compressed air fed to the inner circumferential face of the work socket hole 26 can as well be injected from an air escape hole that is specially formed instead of the upper part of the work socket hole 26.

Further, though in this embodiment the position of the external shape center is determined by finding the internal shape center positions P₁, P₂ and P₃ of images from the three sets of image data obtained at different rotational angles and locating the center position of a circle passing the three internal shape center positions P₁, P₂ and P₃, the position of the external shape center can as well be determined on the basis of two sets of image data obtained at different rotational angles.

In this case, first, the end face of the master work M is imaged twice at different rotational angles, and the rotational angle θ of the master work M at the time is measured. Then, the positions of the internal shape center positions P₁ and P₂ are figured out from the two sets of obtained image data. Next, a circle passing those two internal shape center positions P₁ and P₂ is identified, and its center is computed. Whereas the center of the circle so computed is the center of the master work M, two such circles are identified. Then, polar coordinates having the centers of these two circles as their respective origins are set, and the internal shape center positions P₁ and P₂ at these polar coordinates are figured out. Since the position of the internal shape center position has been shifted by rotation from P₁ to P₂, the set of polar coordinates at which the rotational angle θ takes on a positive value is selected, and the position of the origin of those polar coordinates is taken as the center of the master work M.

It is also possible to determine the position of the external shape center of the master work from the two sets of image data without measuring the rotational angle θ. In this case, for instance, a master work having on its end face two visually perceivable points P and Q is imaged twice at different rotational angles, and the position of the center of the external shape of the master work is figured out on the basis of those two sets of image data. More specifically, first, positions P₁ and Q₁ of points P and Q formed on the end face are determined on the basis of the image data deriving from the first pickup. Similarly, positions P₂ and Q₂ of points P and Q formed on the end face are determined on the basis of the image data deriving from the second pickup. Then, a straight line passing the points P₁ and Q₁ and straight line passing the points P₂ and Q₂ are figured out, and an angle θ formed by the two straight lines is determined. As the angle θ so determined is equal to the rotational angle of the master work, by using this angle θ (=the rotational angle), the position of the external shape center of the master work can be determined by the same method as the foregoing method.

To add, if there is available a mark whose shape can be recognized, there is no need to form two points P and Q on the end face of the master work as described above, but the rotational angle θ of the master work M can be determined from that single mark.

By using the dimensional measuring apparatus 10 in this embodiment, the length of the work can also be measured. This length measurement is carried out in the following manner.

First, a master work of a known length is made ready for use. Then, the master work is inserted into the work socket hole 26. The end of the master work inserted into the work socket hole 26 is engaged with the stopper plate 36 and accommodated within the work socket hole 26.

Next, the lift drive motor 64 is driven to bring down the rod 42 from a predetermined standby position. When the end of the rod 42 has come into contact with the rear end face of the master work accommodated in the work socket hole 26, the descent of the rod 42 is stopped.

Here, the lift drive motor 64 is fitted with the encoder 70 so that the revolutions of its output shaft can be determined. The PC 80 acquires from the encoder 70 the revolutions of the output shaft of the lift drive motor 64 required for the rod 42 to come into contact with the rear end face of the master work. Then the revolutions are stored into the memory as the reference revolutions. This is followed by the above-described procedure to determine the position of the external shape center.

To measure the length of the work, first, the work is inserted into the work socket hole 26. The end of the work inserted into the work socket hole 26 is engaged with the stopper plate 36 and accommodated within the work socket hole 26.

Next, the lift drive motor 64 is driven to bring down the rod 42 from the predetermined standby position. When the end of the rod 42 has come into contact with the rear end face of the work accommodated in the work socket hole 26, the descent of the rod 42 is stopped.

The coming into contact of the end of the rod 42 with the rear end face of the work is determined, for instance, by using a pressure switch.

The PC 80 acquires from the encoder 70 the revolutions of the output shaft of the lift drive motor 64 required for the rod 42 to come into contact with the rear end face of the work. Then, the difference between the revolutions acquired and the reference revolutions is determined, and the work length is computed from that difference.

Thus, as the rod 42 moves up and down in proportion to the revolutions of the lift drive motor 64, the quantity of the shift of the rod 42 can be determined by figuring out its revolutions, and by computing their difference from the reference revolutions, the difference in length from the master work can be determined. Then, as the length of the master work is known, once the difference in length from that master work is found, the length of the work to be measured can be computed.

After the work length is measured as described above, the rod 42 is lifted to the predetermined drive position, and the above-stated measurement of the bore size d and the eccentricity ω is performed.

Thus, the dimensional measuring apparatus 10 in this embodiment can also measure the length of the work.

To add, although the shifting quantity of the rod 42 is computed from the revolutions of the lift drive motor 64, some other appropriate device of measurement can be used as well.

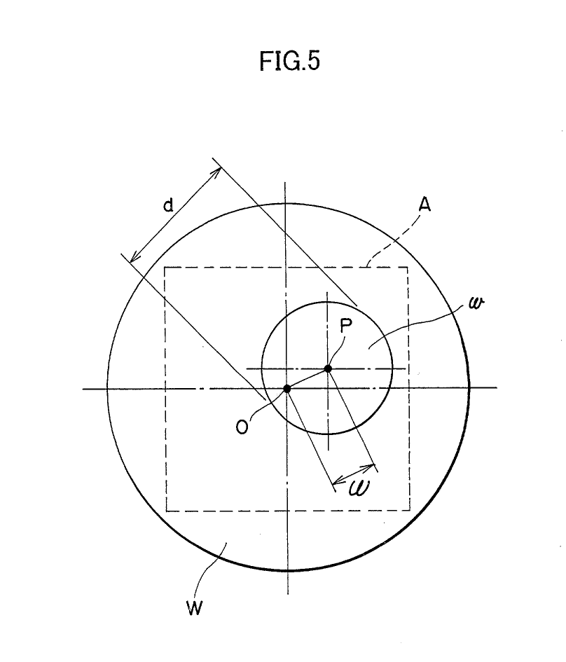

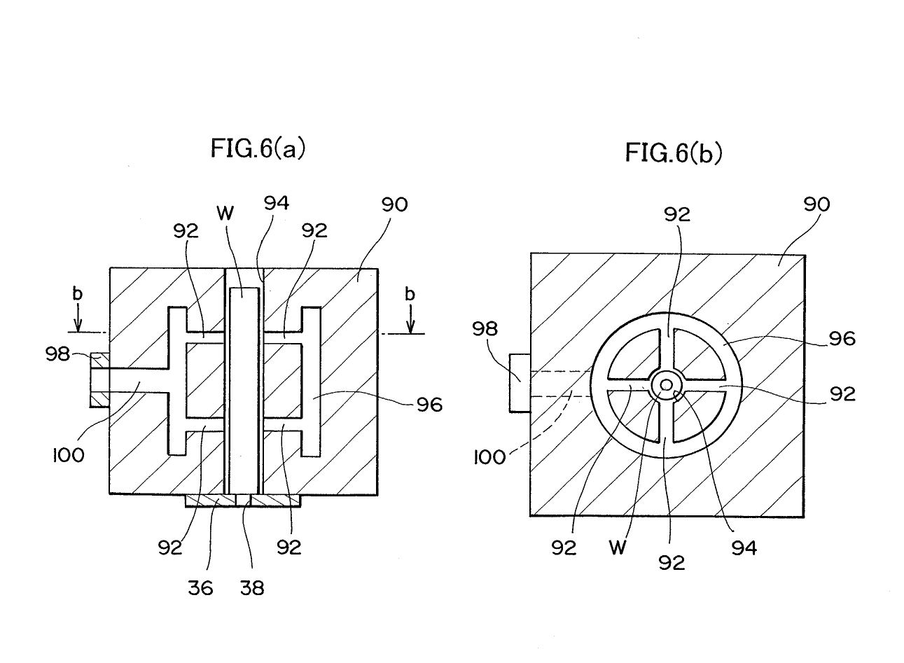

FIG. 6(a) shows a longitudinal section of a work holder in another embodiment, and FIG. 6(b) shows the b-b section of FIG. 6(a). The same members as those of the work holder 22 in the foregoing embodiment are assigned respectively the same reference numerals.

As illustrated in FIGS. 6(a) and 6(b), this work holder 90 holds a work inserted into a work socket hole 94 at the center of the work socket hole 94 by injecting compressed air from radially formed air outlets 92, 92, . . . toward the central part of the work socket hole 94. The air outlets 92, 92, . . . are formed in two rows, upper and lower, each communicating with an annularly formed air feed path 96. This air feed path 96 communicates with an air intake port 98 formed on the outer circumferential face of the work holder 90 via an air channel 100. An air feed device 108 is connected to the air intake port 98 via air feed piping (not shown), and compressed air is fed from this air feed device 108 to the air intake port 98.

In the work holder 90 configured as described above, compressed air fed from the air feed device to the air intake port 98 is supplied to the air feed path 96 via the air channel 100, and injected from the air outlets 92, 92, . . . toward the central part of the work socket hole 94. The work inserted into the work socket hole 94 is thereby held at the center of the work socket hole 94.

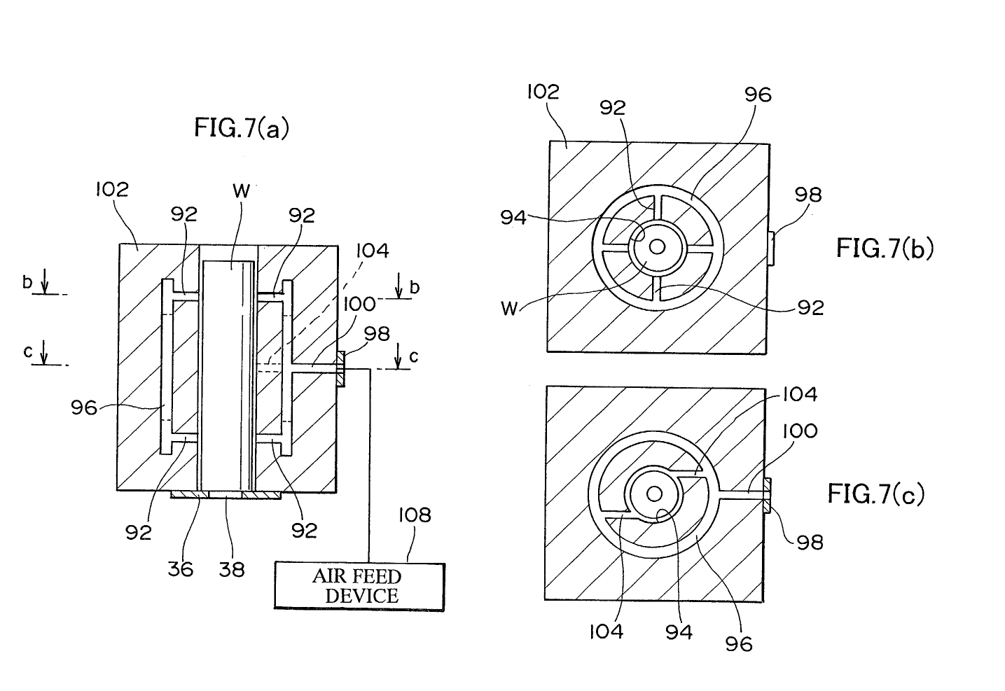

FIG. 7(a) shows a longitudinal section of a work holder having a function to rotate the work. FIGS. 7(b) and 7(c) respectively show the b-b and c-c sections of FIG. 7(a). The same members as those of the work holder 90 in the foregoing embodiment are assigned respectively the same reference numerals.

As illustrated in FIGS. 7(a)-7(c), in a work holder 102, there are formed a pair of air outlets 104 and 104 for rotating the work in addition to the air outlets 92, 92, . . . for centripetal action on the work. This pair of work rotating air outlets 104 and 104 inject air in suitable positions for generating a rotating force on the work inserted into the work socket hole 94. Thus, the pair of air outlets 104 and 104 are formed in positions at equal distances from the center of the work socket hole 94 and in parallel to each other. From these air outlets 104 and 104, equal quantities of compressed air in mutually reverse directions are injected in parallel, and when the injected compressed air hits the circumferential face of the work, a rotating force is generated on the work to rotate it around its axis.

In the work holder 102 configured as described above, compressed air fed from the air feed device to the air intake port 98 is supplied to the air feed path 96 via the air channel 100, and injected from the air outlets 92, 92, . . . toward the central part of the work socket hole 94. The work inserted into the work socket hole 94 is thereby held at the center of the work socket hole 94.

Compressed air fed to the air feed path 96 is also injected from the air outlets 104 and 104 thereby to rotate the work W around its axis. Thus, as equal quantities of compressed air in mutually reverse directions are injected from the air outlets 104 and 104 in parallel, when the injected compressed air hits the circumferential face of the work W, a couple of forces is generated on the work W to rotate it around its axis.

The use of this work holder 102 makes it unnecessary for the rod 42 to have a rotating mechanism, resulting in a more compact configuration.

The work holder 102 in this embodiment can also measure the length of the work by the method described above. Thus, by bringing the rod (contacting element) 42 into contact with an end face of the work inserted into the work socket hole 94 of the work holder 102, the length of the work can be measured on the basis of the shifting quantity of that rod.

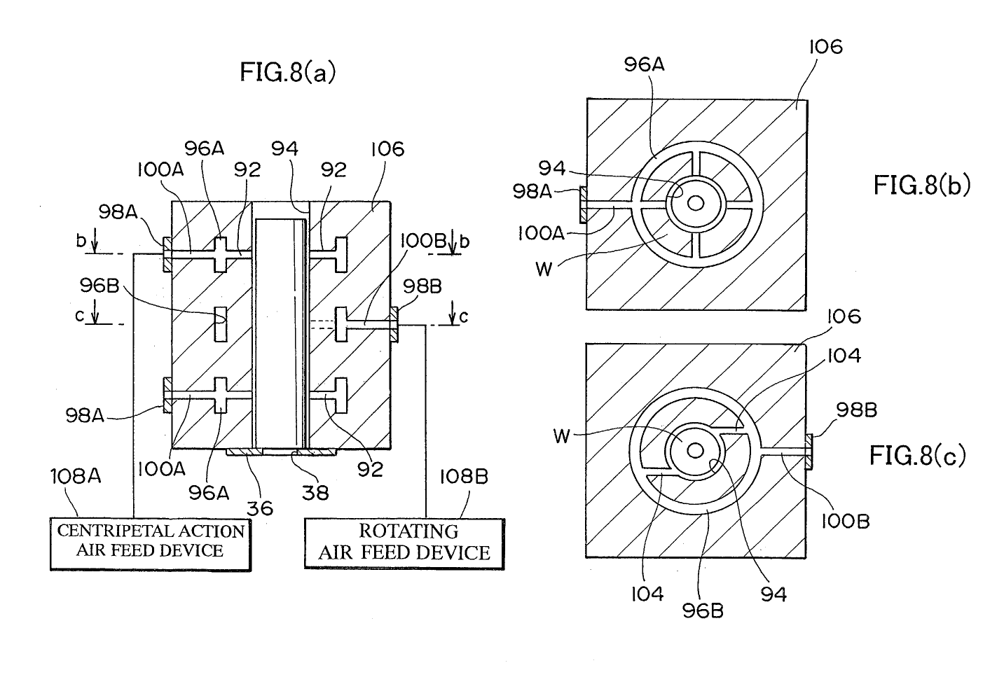

FIG. 8(a) shows a longitudinal section of a work holder having a function to rotate the work in another embodiment. FIGS. 8(b) and 8(c) respectively show the b-b and c-c sections of FIG. 8(a). The same members as those of the work holders 90 and 102 in the foregoing embodiment are assigned respectively the same reference numerals.

As illustrated in FIGS. 8(a)-8(c), a work holder 106 in this embodiment has separately a circuit for feeding compressed air to the air outlets 92 for centripetal action on the work and another for feeding compressed air to the work rotating air outlets 104.

Thus, as illustrated in FIGS. 8(a) and 8(b), the air outlets 92, 92, . . . for centripetal action communicate with annularly formed air feed paths 96A and 96A for centripetal action, while the work rotating air outlets 104 communicate with an annularly formed rotating air feed path 96B.

The air feed paths 96A and 96A for centripetal action communicate with air intake ports 98A and 98A for centripetal action, formed on the outer circumferential face of the work holder 106, via air channels 100A and 100A for centripetal action, and to these air intake ports 98A is connected an air feed device 108A for centripetal action via air feed piping for centripetal action (not shown). Compressed air is supplied from this air feed device 108A for centripetal action.

On the other hand, the rotating air feed path 96B communicates with a rotating air intake port 98B, formed on the outer circumferential face of the work holder 106, via a rotating air channel 100B, and to this rotating air intake port 98B is connected a rotating air feed device 108B via rotating air feed piping (not shown). Compressed air is supplied from this rotating air feed device 108B.

In the work holder 106 configured as described above, when compressed air is fed from the air feed device 108A for centripetal action to the air intake ports 98A and 98A for centripetal action, that compressed air is supplied to the air feed paths 96A and 96A via the air channels 100A and 100A for centripetal action, and injected from the air outlets 92, 92, . . . for centripetal action toward the central part of the work socket hole 94. The work inserted into the work socket hole 94 is thereby held at the center of the work socket hole 94.

When compressed air is fed from the rotating air feed device 108B to the rotating air intake port 98B, that compressed air is supplied to the rotating air feed path 96B via the rotating air channel 100B, and injected from the rotating air outlets 104 and 104. This causes the work W to rotate around its axis. Thus, as equal quantities of compressed air in mutually reverse directions are injected from the air outlets 104 and 104 in parallel, when the injected compressed air hits the circumferential face of the work W, there arises a couple of forces to rotate the work W around its axis.

The use of this work holder 106, as does the use of the aforementioned work holder 102, makes it unnecessary for the rod 42 to have a rotating mechanism, resulting in a more compact configuration.

The work holder 106 in this embodiment, since the work can be rotated only when rotating air feed device 108B is driven, permits choice between a rotating state and a stationary state.

The work holder 106 in this embodiment can also measure the length of the work by the method described above. Thus, by bringing the rod (contacting element) 42 into contact with an end face of the work inserted into the work socket hole 94 of the work holder 106, the length of the work can be measured on the basis of the shifting quantity of that rod.

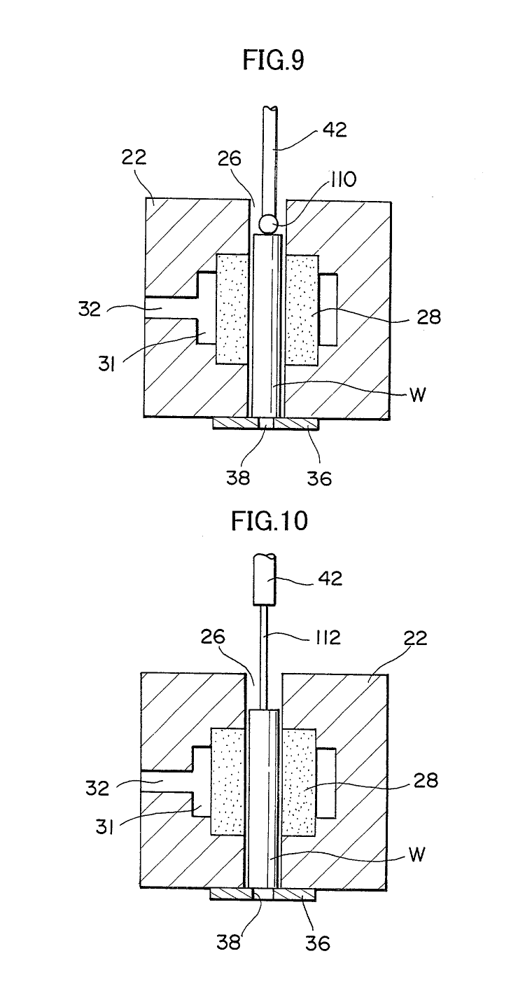

FIG. 9 shows a longitudinal section of the configuration of an essential part of a rotation drive mechanism in another embodiment.

In the foregoing embodiment, the work is lifted by the action of compressed air injected from the inner circumferential face of the work socket hole 94 to bring it into contact with the end face of the rod 42 to support it. However, where the rear end face of the work is brought into contact with the end face of the rod 42 in this way, it may become impossible to subject the work to centripetal action by compressed air if the friction between the rod 42 and the work becomes too great.

In view of this risk, a sphere 110 is fixed to the end of the rod 42 as illustrated in FIG. 9, and the end of the rod 42 is brought into contact with the rear end face of the work via this sphere 110. This results in point contact between the two end faces, which can prevent the frictional force from becoming too great to subject the work to centripetal action.

Incidentally, the sphere 110 may as well be placed intervening between the rod 42 and the work instead of fixing it to the end of the rod 42.

Another conceivable method is to fix a wire 112 to the end of the rod 42 and support the work with the end of this wire 112 as illustrated in FIG. 10. This enables the work W to be subjected to centripetal action by the flexure (elastic deformation) of the wire 112.

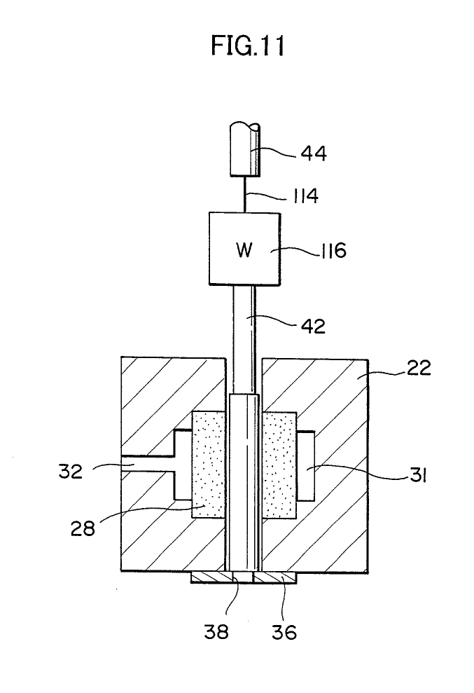

Still another alternative is to fix a weight 116 (a weight heavier than the buoyancy of the work W) to the rotation shaft 44 via a thread 114, and fit the rod 42 via that weight 116 as illustrated in FIG. 11. This enables the work W to be subjected to centripetal action by the flexure of the thread 114 even if the friction between the rod 42 and the work W is great.

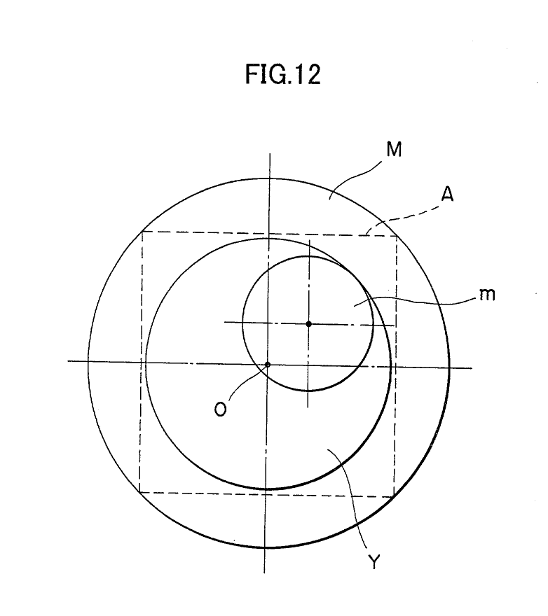

FIG. 12 illustrates an external shape center position determining method for a master work in another embodiment.

When the master work M is rotated at high speed, the end face of the master work M imaged by the CCD camera 76 shows a circle Y where the bore m has passed as shown in FIG. 12. The PC 80 determines the position O of the external shape center O of the master work W by computing the center of this circle Y.

By this method, too, the position of the external shape center O of the master work M can be effectively determined.

Determination of the center position of a circle from an image obtained by a CCD can be accomplished by any of various known image processing techniques, for instance from the contour, from the area center of gravity or from the midpoints of dimensions X and Y.

While in this embodiment part of an end face of the work (rectangular area A including the bore) is imaged, and the eccentricity, bore and other dimensions are figured out on the basis of the image data thereby obtained, it is also conceivable to image the whole end face of the work and compute these factors from the resultant image data. Partial imaging of the end face of the work as in this embodiment the magnification of pickup can be increased, making possible accurate measurement where a CCD with a smaller number of pixels is used.

Further, in this embodiment, a cylindrical work is to be measured, but the measurable objects are not limited to this, but any work having on its end face a visually perceivable portion can be used.

As hitherto described, according to the present invention, the position of the external shape center of a work can be easily and accurately determined by merely using a work having on its end face a visually perceivable portion. Therefore, the position of the external shape center of even an infinitesimal work can be easily and accurately determined.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A work center position determining method for a work having a visually recognizable portion on an end face thereof, the method comprising the steps of:
rotating the work in a circumferential direction thereof;
imaging the end face of the work with an image pickup device; and
determining, from an image obtained in the imaging step, a position of an external shape center of the end face of the work projected on the image pickup device.

2. The work center position determining method as set forth in claim 1, wherein the work is inserted into a work socket hole, held at a center of the work socket hole by injecting air from an inner circumferential face of the work socket hole toward inside the work socket hole, and rotated by bringing a rotating body into contact with the other end face of the work than the imaged end face.

3. The work center position determining method as set forth in claim 1, wherein the work is inserted into a work socket hole, held at a center of the work socket hole by injecting air from an inner circumferential face of the work socket hole toward inside the work socket hole, and rotated by injecting air from the inner circumferential face of the work socket hole to a position where a rotational force is generated on the work.

4. The work center position determining method as set forth in claim 1, wherein the position of the external shape center of the end face of the work projected on the image pickup device is determined by imaging the end face of the work with the image pickup device a plurality of times at different rotational angles and figuring out a position of a center of a circle passing every portion visually perceived from a plurality of obtained images.

5. The work center position determining method as set forth in claim 4, wherein the work is inserted into a work socket hole, held at a center of the work socket hole by injecting air from an inner circumferential face of the work socket hole toward inside the work socket hole, and rotated by bringing a rotating body into contact with the other end face of the work than the imaged end face.

6. The work center position determining method as set forth in claim 4, wherein the work is inserted into a work socket hole, held at a center of the work socket hole by injecting air from an inner circumferential face of the work socket hole toward inside the work socket hole, and rotated by injecting air from the inner circumferential face of the work socket hole to a position where a rotational force is generated on the work.

7. A work center position determining apparatus for a work having a visually recognizable portion on an end face thereof, the apparatus comprising:
a work holding device which holds the work;
a rotating device which rotates the work held by the work holding device in a circumferential direction of the work;
an image pickup device which images an end face of the work held by the work holding device; and
an external shape center position computing device which computes, from an image obtained by the image pickup device, a position of an external shape center of the end face of the work projected on the image pickup device.

8. The work center position determining apparatus as set forth in claim 7, wherein the external shape center position computing device computes the position of the external shape center of the end face of the work projected on the image pickup device by figuring out a position of a center of a circle passing every portion visually perceived from a plurality of images obtained by imaging the end face of the work a plurality of times at different rotational angles by the image pickup device.

9. The work center position determining apparatus as set forth in claim 7, wherein the work holding device comprises:
a work socket hole into which the work is inserted; and
an air injecting device which holds the work inserted into the work socket hole at a center of the work socket hole by injecting air from an inner circumferential face of the work socket hole toward inside the work socket hole.

10. The work center position determining apparatus as set forth in claim 7, wherein the rotating device brings a rotating body into contact with the end face of the work and rotates the work in the circumferential direction by a frictional force therebetween.

11. The work center position determining apparatus as set forth in claim 10, wherein the rotating body is a rod rotating in the circumferential direction.

12. The work center position determining apparatus as set forth in claim 10, further comprising:
a shifting device which shifts the rotating device back and forth along an axis of the work socket hole;
a shifting quantity measuring device which measures a shifting quantity of the rotating device; and
a computing device which computes a length of the work according to the shifting quantity of the rotating device measured by the shifting quantity measuring device.

13. A work center position determining apparatus for a work having a visually recognizable portion on an end face thereof, the apparatus comprising:
a work socket hole into which the work is inserted;
a centripetal action air injecting device which holds the work inserted into the work socket hole at a center of the work socket hole by injecting air from an inner circumferential face of the work socket hole toward inside the work socket hole;
a rotating air injecting device which rotates the work by injecting air from the inner circumferential face of the work socket hole to a position where a rotational force is generated on the work and causing the air to hit an outer circumferential face of the work;
an image pickup device which images the end face of the work inserted into the work socket hole; and
a computing device which computes a position of an external shape center of the end face of the work projected on the image pickup device by figuring out a position of a center of a circle passing every portion visually perceived from a plurality of images obtained by imaging the end face of the work a plurality of times at different rotational angles by the image pickup device.

14. The work center position determining apparatus as set forth in claim 13, wherein the centripetal action air injecting device and the rotating air injecting device are fed with air from a common air supply source.

15. The work center position determining apparatus as set forth in claim 13, wherein the centripetal action air injecting device and the rotating air injecting device are individually fed with air from different air supply sources.

16. The work center position determining apparatus as set forth in claim 13, further comprising:
a contacting element which is brought into contact with the end face of the work inserted into the work socket hole;
a shifting device which shifts the contacting element back and forth along an axis of the work socket hole;
a shifting quantity measuring device which measures a shifting quantity of the contacting element; and
a computing device which computes a length of the work according to the shifting quantity of the contacting element measured by the shifting quantity measuring device.
